(19) United States
(12) Patent Application Publication
(10) Pub. No.: US 2014/0249771 A1
(43) Pub. Date: Sep. 4, 2014

(54) LOCATION ESTIMATION USING A MOBILE DEVICE

(71) Applicants: XUE YANG, Arcadia, CA (US); LEI YANG, Hillsboro, OR (US); MARTIN JUNKAR, San Jose, CA (US); UTTAM K. SENGUPTA, Portland, OR (US)

(72) Inventors: XUE YANG, Arcadia, CA (US); LEI YANG, Hillsboro, OR (US); MARTIN JUNKAR, San Jose, CA (US); UTTAM K. SENGUPTA, Portland, OR (US)

(21) Appl. No.: 13/782,472

(22) Filed: Mar. 1, 2013

(51) Int. Cl. G01B 7/00

(52) U.S. Cl. CPC G01B 7/003
USPC 702/150

(57) ABSTRACT

The present disclosure relates to computer-implemented systems and methods for location estimation using a mobile device. An example method may include receiving, at a device, one or more signature measurements associated with an indoor environment. Additionally, the device may be associated with a user. The method may also include receiving, at the device, one or more motion tracking measurements to measure relative motion associated with the device and the user. Furthermore, the method may include associating the one or more signature measurements with one or more virtual landmarks identified within the indoor environment. The method may further include determining a location of the user based on the one or more signature measurements, the one or more motion tracking measurements, and the one or more virtual landmarks.

### TECHNICAL FIELD

The present disclosure generally relates to location estimation, and in particular, to location estimation using a mobile device.

### BACKGROUND

Recently, deriving and/or estimating indoor location information has grown increasingly important. One method of estimating the indoor location associated with a device may be to employ specialized hardware such as Bluetooth low energy, ultra-wide band, and/or the like. Other strategies may involve generating a wireless signal map from various clusters of wireless access points. On the other hand, cost of deployment and/or estimation accuracy of certain strategies may still serve as hindrances.

### BRIEF DESCRIPTION OF THE DRAWINGS

Reference will now be made to the accompanying figures and diagrams, which are not necessarily drawn to scale, and wherein:

FIG. 1 shows a system for location estimation using a mobile device according to one or more example embodiments.

FIG. 2A shows a mobile device for location estimation according to one or more example embodiments.

FIG. 2B shows a block diagram of another system for location estimation using a mobile device, according to one or more example embodiments.

FIG. 2C shows a block diagram of yet another system for location estimation using a mobile device, according to one or more example embodiments.

FIG. 3 shows a system for relative motion tracking for location estimation using a mobile device, according to one or more example embodiments.

FIG. 4 shows a flow diagram of an example environment suitable for implementing methods for location estimation using a mobile device, according to one or more example embodiments.

### DETAILED DESCRIPTION

In the following description, numerous specific details are set forth. However, it should be understood that embodiments of the present disclosure may be practiced without these specific details. In other instances, well-known methods, structures, and techniques have not been shown in detail in order not to obscure an understanding of this description. References to “one embodiment,” “an embodiment,” “example embodiment,” “various embodiments,” and so forth indicate that the embodiment(s) of the present disclosure so described may include a particular feature, structure, or characteristic, but not every embodiment necessarily includes the particular feature, structure, or characteristic. Furthermore, repeated use of the phrase “in one embodiment” does not necessarily refer to the same embodiment, although it may.

As used herein, unless otherwise specified, the use of the ordinal adjectives “first,” “second,” “third,” etc., to describe a common object merely indicates that different instances of like objects are being referred to and are not intended to imply that the objects so described must be in a given sequence, either temporally, spatially, in ranking, or in any other manner.

As used herein, unless otherwise specified, the term “mobile device” refers, in general, to a wireless communication device, and more particularly to one or more of the following: a portable electronic device, a telephone (e.g., cellular phone, smart phone), a computer (e.g., laptop computer, tablet computer), a portable media player, a personal digital assistant (PDA), or any other electronic device having a networked capability.

As used herein, unless otherwise specified, the term “server” may refer to any computing device having a networked connectivity and configured to provide one or more dedicated services to clients, such as a mobile device. The services may include storage of data or any kind of data processing. One example of the central server includes a web server hosting one or more web pages. Some examples of web pages may include social networking web pages. Another example of a server may be a cloud server that hosts web services for one or more computer devices.

The present disclosure relates to computer-implemented systems and methods for location estimation using a mobile device. According to one or more embodiments of the disclosure, a method is provided. The method may include receiving, at a device, one or more signature measurements associated with an indoor environment. Additionally, the device may be associated with a user. The method may also include receiving, at the device, one or more motion tracking measurements to measure relative motion associated with the device and the user. Furthermore, the method may include associating the one or more signature measurements with one or more virtual landmarks identified within the indoor environment. The method may further include determining a location of the user based on the one or more signature measurements, the one or more motion tracking measurements, and the one or more virtual landmarks.

According to one or more embodiments of the disclosure, a system is provided. The system may include at least one memory for storing data and computer-executable instructions. Additionally, the system may also include at least one processor to access the at least one memory and to execute the computer-executable instructions. Furthermore, the at least one processor may be configured to execute the instructions to receive, at the device, one or more signature measurements associated with an indoor environment. The at least one processor may also execute the instructions to receive one or more motion tracking measurements to measure relative motion associated with a device and a user associated with the device. Furthermore, the at least one processor may execute the instructions to associate the one or more signature measurements with one or more virtual landmarks identified within the indoor environment. The at least one processor may also execute the instructions to determine a location of the user based on the one or more signature measurements, the one or more motion tracking measurements, and the one or more virtual landmarks.

According to one or more embodiments of the disclosure, a non-transitory computer-readable medium is provided. The non-transitory computer-readable medium may have embodied thereon instructions executable by one or more processors. The instructions may cause the one or more processors to receive, at a device, one or more signature measurements associated with an indoor environment. As such, the device may be associated with a user. Additionally, the computer-readable medium may include instructions to receive, at the device, one or more motion tracking measurements to measure relative motion of the device and relative motion between the device and the user. Moreover, the computer-readable medium may include instructions to associate the one or more signature measurements with one or more virtual landmarks identified within the indoor environment. In addition, the medium may include instructions to generate a database to store one or more signature-landmark associations between the one or more signature measurements and the one or more virtual landmarks. The computer-readable medium may include further instructions to determine a location of the user based on the one or more signature measurements, the one or more motion tracking measurements, and the one or more virtual landmarks. In some embodiments, the one or more virtual landmarks may be identified by respective combinations of the one or more signature measurements and one or more coordinate locations.

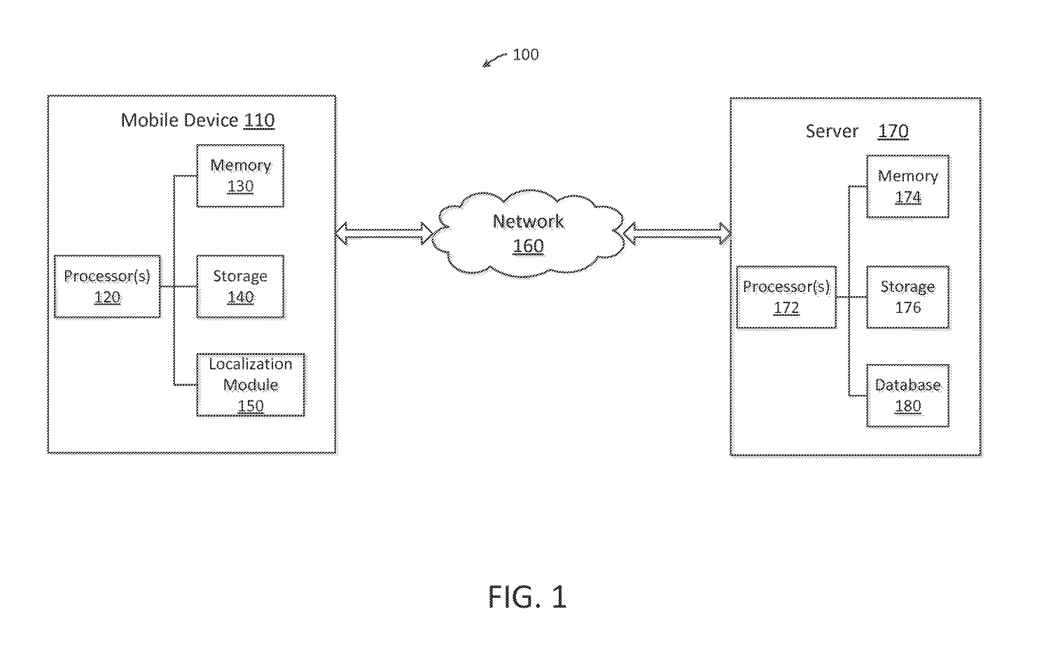

The above principles, as well as perhaps others, are now illustrated with reference to FIG. 1, which depicts a system 100 for estimating location information. The system 100 may include a mobile device 110 having one or more processors 120, a memory 130, a storage 140, and a localization and database generation module 150 in communication with each other. The memory 130 may be configured to store instructions to be executed by the processor(s) 120. The memory 130 may be any type of memory including, but not limited to, random access memory, flash memory, read-only memory, and/or any persistent or non-persistent memory.

The storage 140 may be used to store any data to be accessed by the processor and/or any other component. Thus, the storage 140 may be any storage device such as a hard disk drive, a tape drive, a solid state drive, a floppy disk drive, a CD-ROM, a DVD-ROM, a Blu-ray disc, random access memory, flash memory, direct access memory, and/or the like.

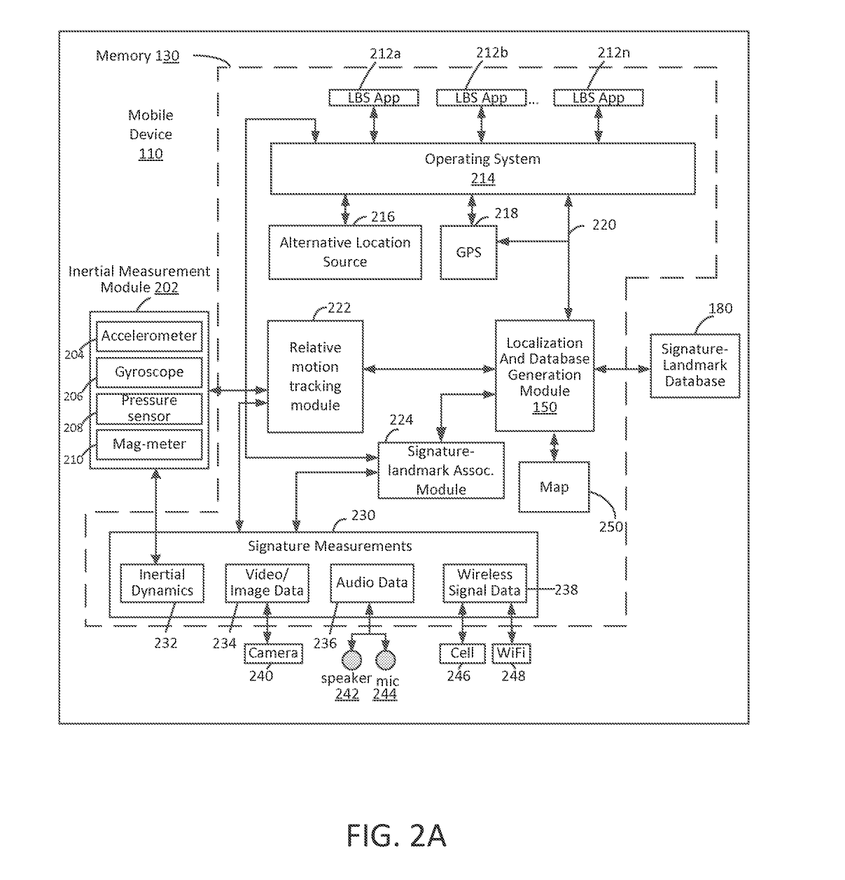

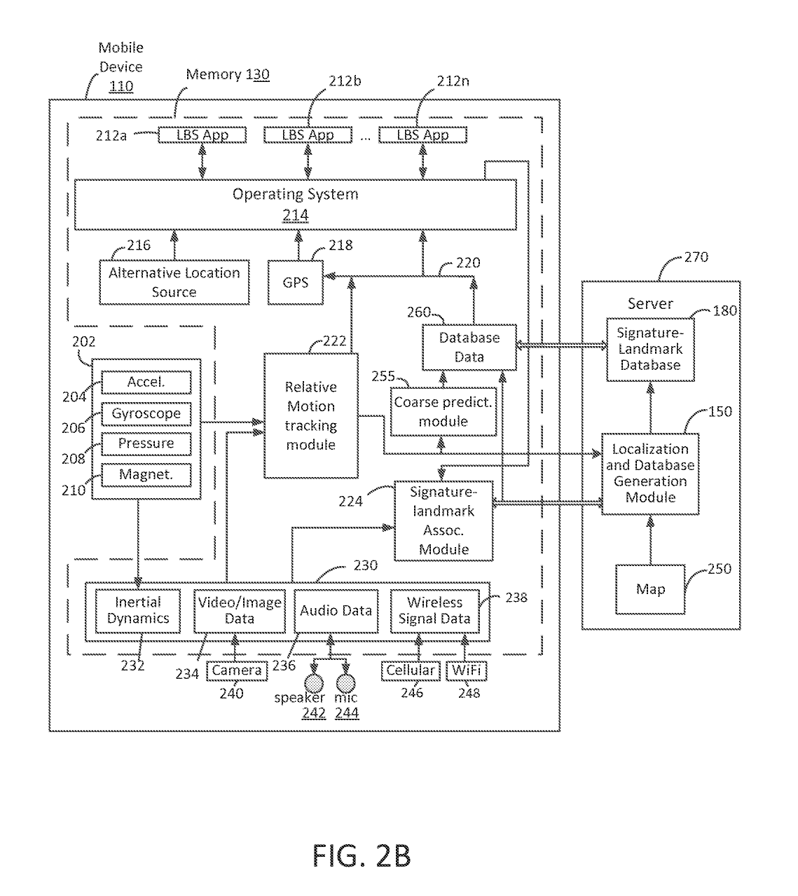

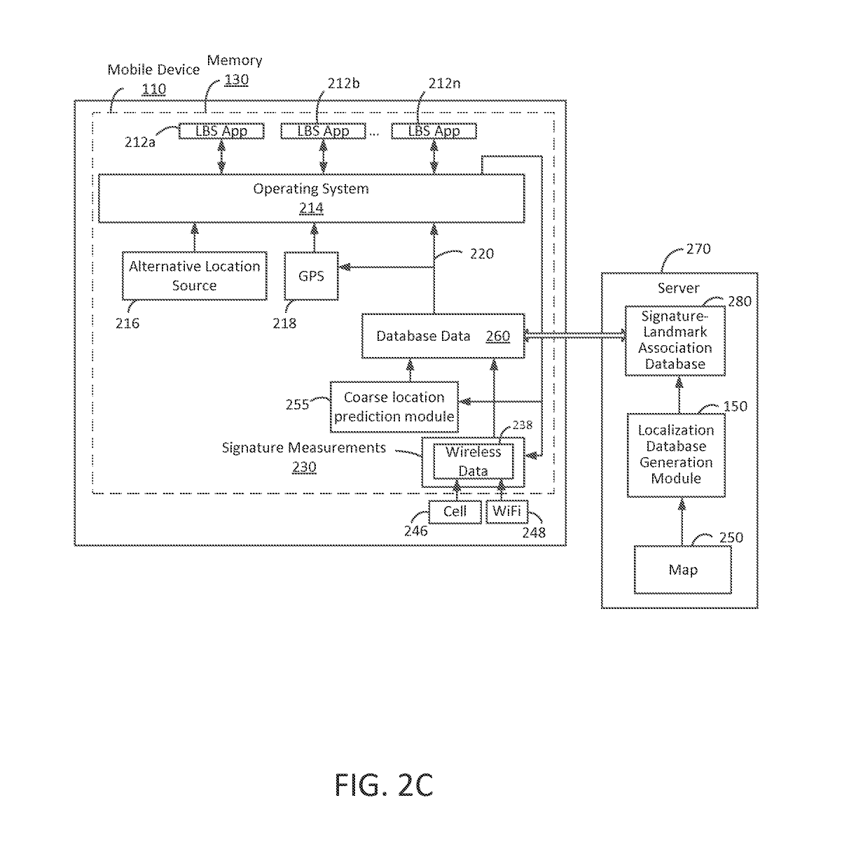

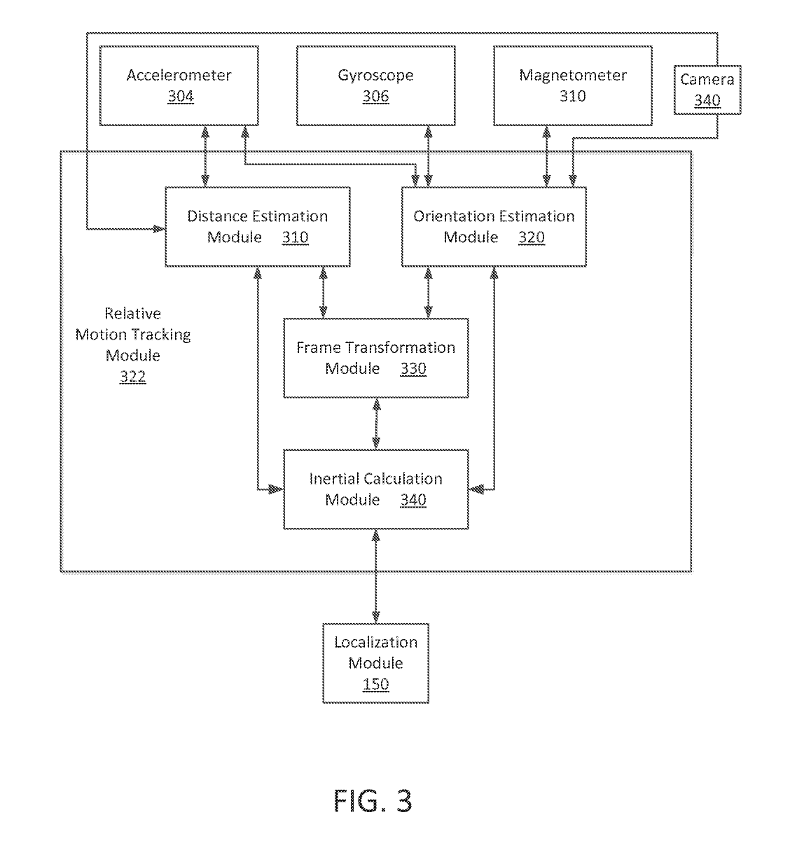

Additionally, the mobile device 110 may also include a localization and database generation module 150 to facilitate the determination and/or estimation of the location of the mobile device 110. In some embodiments, the localization and database generation module 150 may be used to generate or facilitate the generation of a database 180 storing signature-landmark associations. Furthermore, the localization and database generation module 150 may determine an indoor location of the mobile device 110 based on the signature-landmark associations. Additionally, in some embodiments, the localization and database generation module 150 may include the processor(s) 120 and/or may include its own processor. The localization and database generation module 150 will be described in more detail below with references to FIGS. 2A-B and FIG. 3.

According to some embodiments, the system 100 may also include a server 170 in communication with the mobile device 110 by way of a network 160. The network 160 may include a local area network (LAN), a wide area network (WAN), the Internet, a Wi-Fi network, an ad-hoc wireless network, a Bluetooth network, and/or any other wired or wireless network, whether private or public. The server may also include one or more processors 172 in communication with memory 174, storage 176, and a database 180. Furthermore, the database 180 may store information used to determine location information associated with the mobile device 110. In some embodiments, the database 180 may be included in the mobile device 110 instead of the server 170, or in both the mobile device 110 and the server 170. The mobile device 110 and the database 180 will be described more fully in conjunction with the discussion of subsequent figures.

FIG. 2A depicts a mobile device 110 capable of determining location information according to one or more embodiments. In particular, according to some embodiments, FIG. 2A may depict a mobile device 110 having relatively high processing capability. In some embodiments, the mobile device 110 illustrated in FIG. 2A may be referred to as a fat mobile device. As previously mentioned, the mobile device 110 may include a localization and database generation module 150. In some embodiments, the mobile device 110 may also include an operating system 214. The operating system 214 may interface/communicate with any number of location-based service (LBS) applications 212a-n that may desire location information associated with the mobile device 110, and by extension, the user. For example, in some embodiments, the LBS applications may operate under an assumption that the user will carry the mobile device 110, and therefore, the location of the user and the mobile device are the same.

As depicted in FIG. 2A, various components and data associated with the mobile device 110 may be included and/or stored in memory 130. However, in other embodiments, the functionality of these components (e.g., the Operating System 214, relative motion tracking module 222, localization and database generation module 150, etc.) may be provided by various processors (e.g., processor(s) 120), software, hardware, associated with the mobile device 110, and/or any combination thereof. Similarly, any data (e.g., signature measurements 230) depicted as being stored in memory 130 may also be stored in other components of the mobile device 110, or may be stored remotely from the mobile device 110.

In addition, the mobile device 110 may include an inertial measurement module 202 to measure the inertial dynamics of the mobile device 110 at any point in time. As such, the inertial measurement module 202 may include an accelerometer 204, a gyroscope 206, a pressure sensor 208, or a magnetometer 210. The accelerometer 204 may measure kinetic dynamics (e.g., proper acceleration) experienced by the mobile device 110 while the gyroscope may measure its angular acceleration. The pressure sensor 208 may measure atmospheric pressure or other types of pressure experienced by the mobile device 110 and may be any type of pressure sensor such as a barometer and/or the like. The magnetometer 210 may be used to measure magnetic distortion experienced by the mobile device 110.

Furthermore, while FIG. 2A illustrates the inertial measurement module 202 as including the above four measurement devices, it should be understood that other embodiments may include more or less measurement devices to measure the inertial dynamics of the mobile device 110.

According to one or more embodiments, the mobile device 110 may also include signature measurements 230. In general, signature measurements 230 may be measurements collected by various sensors with respect to a particular environment. Thus, signature measurements 230 may include inertial dynamics data 232, video/image data, 234, audio data 236, and wireless signal data 238. To this end, the signature measurements 230 may include information and/or data related to detecting the physical environment experienced by the mobile device 110, and by extension, a user of the mobile device.

As such, the signature measurements 230 may be received from various sensors included and/or in communication with the mobile device 110. For example, the inertial dynamics data 232 may be received from the inertial measurement module 202 while the video/image data 234 may be received from a camera 240. Additionally, the audio data 236 may be received from one or both of a speaker 242 and a microphone 248. The wireless signal data 238 may be received from a cellular radio 246, a WiFi radio 248, and/or any other wireless signal radio or combination of wireless signal radios. In other embodiments, the signature measurements 230 may be received from other mobile devices in communication with the mobile device 110 through the network 160. In yet other embodiments, the signature measurements 230 may be received from the server 170.

According to some embodiments, the speaker 242 and the microphone 244 may be leveraged to generate a sound propagation delay profile. Thus, the speaker 242 and microphone 244 combination may be configured to calculate sound propagation properties specific to an indoor environment or any other environment. For example, the speaker 242 may be configured to transmit sound (e.g., ultrasound) while the microphone 244 may receive echoes reflected back from different surfaces in the environment, such as within a room. Various factors associated with the environment, such as a room layout, wall materials, and/or other factors may affect the calculation of a sound propagation delay profile. Alternatively, instead calculating a sound propagation profile, the speaker 242 and microphone 244 may simply be used to detect ambient sounds that may correspond to particular regions in the indoor environment.

In other embodiments, the camera 240 may be configured to calculate certain visual based signature measurements 230. For example, the camera's 240 recognition of an object, such as a front door, may be used to determine that the mobile device 110 is relatively close to the object/front door. In some embodiments, depending on the processing capabilities, and or power requirements of the mobile device 110, the mobile device may elect not to capture one or more of the signature measurements 230. For example, due to possible poor illumination conditions present in indoor environments, as well as potential viewpoint changes of the camera 240 resulting from movement of the mobile device 110, processing requirements associated with the camera may be relatively high. Thus, in situations where the mobile device 110 may have less processing capabilities than that of a fat mobile device, the data from the camera 240 may be omitted when aggregating signature measurements 230. Additionally, the mobile device may also decided to forgo collecting data from the camera 240 if the mobile device 110 wishes to conserve power.

According to one or more embodiments, wireless signal data 238 from the wireless signal radios (e.g., cellular radio 246 and WiFi radio 248) may also be used for signature measurements 230. For example, radio signals may attenuate as they propagate through space. Thus, the radio signal strength experienced by the cellular radio 246 and/or the WiFi radio 248 may provide a portion of the signature measurements 230 as part of the wireless signal data 248.

Additionally, both radios may be configured to determine a radio propagation delay profile. For instance, the time of flight associated with a radio wave(s) may be another form of signature measurements 230 as wireless signal data 248. To this end, radio wave propagation may be relatively sensitive to indoor multi-path conditions. As such, direct signal paths, reflected signal paths, and/or diffracted signal paths may all contribute to one or more finals signals observed at a radio receiver (e.g. cellular radio 246 and/or WiFi radio 248). Furthermore, it may be observed that for a particular location, a radio propagation delay profile may tend to remain relatively static and unchanged over relatively long periods of time. Thus, the wireless radios (e.g., cellular radio 246 and/or WiFi radio 248) may communicate with various access points and/or base stations (such as an eNodeB in a Long Term Evolution network) to perform calculations related to time-of-flight or time-difference-of-arrival measurements of wireless signals, as the mobile device 110 moves through an indoor environment.

In addition, the signature measurements 230 may also include measurements 230 performed by the various sensors included in the inertial measurement module 202 and output as inertial dynamics data 232. For example, the magnetometer 210 may provide certain signature measurements 230 related to distortions in the magnetic field associated with a certain location. Indeed, in indoor environments, electrical devices (e.g., mobile device 110) and/or ferromagnetic structures within the indoor environments may cause deviations in indoor magnetic fields. Such deviations or distortions may be designated as distinctive location signatures to be used as signature measurements 230 with respect to inertial dynamics data 232.

In some embodiments, a signature-landmark association module 224 may be configured to receive the signature measurements 230. In other words, the signature-landmark association module 224 may be able to designate particular combinations of signature measurements 230 as virtual landmarks. Thus, a virtual landmark may be defined as a particular set or combination of signature measurements. In some embodiments, the localization and database generation module 150 may use the output of the signature-landmark association module 224 to associate a coordinate location with the signature measurements 230 and virtual landmarks. To this end, the coordinate location may be associated with a map 250, which may be a physical floormap, for example. Thus, in some implementations, a virtual landmark may represent a particular combination of signature measurements 230 and coordinate location(s). Indeed, virtual landmarks can thus be distinguished from each other based on respective combinations of signature measurements 230 and coordinate location(s). For instance, if a room were to be divided into a 2×2 grid, and each grid area can be distinguished with respective sets of signature measurements 230 and coordinate locations(s), then each grid area may be considered/identified as a virtual landmark.

According to certain embodiments, the signature-landmark association module 224 may output data to the localization and database generation module 150, which may use such data to generate signature-landmark data to be stored in the signature-landmark database 180 and/or to perform localization functions. For example, the localization and database generation module 150 may determine a location and/or approximate location of the mobile device 110, and by extension, the user. Additionally, the localization and database generation module 150 may also determine the location of one or more virtual landmarks associated with the indoor environment. In some implementations, the localization and database generation module 150 may determine the location of the mobile device 110 and/or the virtual landmarks by determining the relative distance between the mobile device 110 and the virtual landmarks.

According to one or more embodiments, the mobile device 110 may also include a relative motion tracking module 222. The relative motion tracking module 222 may be able to receive information from the inertial measurement module 202 and the signature measurements 230. To this end, the relative motion tracking module 222 may use signature measurements 230 (e.g., video/image data 234 from the camera 240) to correct for errors that may be present in calculations performed by the inertial measurement module 202. For example, video/image data 234 received from the camera 240 may be used to adjust for distance and orientation errors output by the inertial measurement module 202.

According to one or more embodiments, the relative motion tracking module 222 may also analyze information from the inertial measurement module 202 and the signature measurements 230 to perform calculations related to determining the motion and orientation of the mobile device 110 and the relative motion between the device 110 and the user. For example, mobile devices 110, when handled by a user, may be in constant motion relative to the user (e.g., when the mobile device 110 is being held by the user while the user is walking, running, performing hand motions, and/or the like). Thus, sensors associated with the mobile device, such as the camera 240, the speaker 242, the microphone 244, and/or the wireless signal radios (i.e., cellular 246 and WiFi 248 radios) may constantly be changing positions relative to the user. Thus, the data measured by such sensors may be associated with inconsistent positions relative to the user, which may result in measurement errors. As an example, the camera 240 may travel some distance and end up facing an entirely different direction as the user transfers the mobile device 110 from one hand to the other. Therefore, the relative motion tracking module 222 may be configured to adjust and/or correct for varying positions of the mobile device 110 (in the case, the camera 240) relative to the user.

According to some embodiments, and as previously discussed above, the mobile device 110 may also include a localization and database generation module 150. The localization and database generation module 150 may be configured to receive outputs of the relative motion tracking module 222 and the signature-landmark association module 224. Additionally, the localization and database generation module 150 may be in communication with a signature-landmark database 180, which may store one or more signature-landmark associations. In general, signature-landmark associations may associate certain combination of signature measurements 230 with certain virtual landmarks. In some implementations, the signature-landmark database 180 may store one or more signature-landmark associations generated by the localization and database generation module 150. To this end, the signature-landmark database 180 may correspond to a particular environment, such as a particular building associated with the user. Alternatively, it may be associated with multiple environments.

In some implementations, the signature-landmark database 180 may provide data that may be used to determine a virtual representation of the indoor environment. In some embodiments, the signature-landmark database 180 may include information that may be used to generate a representation of the indoor environment as various divisions of different cells. Under this framework, each cell may correspond to a particular region of the indoor environment. Furthermore, the size of each cell may vary according to location accuracy requirements of location based applications 212a-n. Therefore, due to the cell-specific representation provided by the signature-landmark database 180, each cell may be configured to provide different types of representations. For example, if a cell corresponds to a specific room in the indoor environment, the cell may represent a topology map for the room. If a cell corresponds to a grid area with defined dimensions, then the cell may represent a grid map for the corresponding area.

In some embodiments, after receiving data from the relative motion tracking module 222, the signature-landmark association module 234, and the map 250, the localization and database generation module 150 may determine a location of the mobile device 100, and by extension, the user. For example, the localization and database generation module 150 may receive signature measurements 230 either directly, or it may receive them from the signature-landmark association module 224. The localization and database generation module 150 may analyze the data sent from the relative motion tracking module 222, which may adjust the signature measurements 230 accordingly (the relative motion tracking module 222 and its adjustments are discussed in more detail with reference to FIG. 3). These adjustments may be to compensate for any changes in position of the mobile device 110 itself as well as changes in orientation of the mobile device 110 relative to the user. The localization and database generation module 150 may then use the adjusted signature measurements 230 to determine a location of the mobile device 110 as well as generate appropriate signature-landmark associations to be stored in the signature-landmark database 180. To this end, the localization and database generation module 150 may generate the signature-landmark database and/or portions thereof. localization and database generation module

As described above, the localization and database generation module 150 may designate and/or generate one or more new virtual landmarks (.e.g., with signature measurement 230 associations). The localization and database generation module 150 may also associate the new virtual landmarks with corresponding positions on the map 250 (e.g., a cell within the map 250.). Thereafter, the localization and database generation module 150 may store the associations (e.g., between the signature measurements 230, virtual landmark, and coordinates on map 250) into the signature-landmark database 180.

Additionally, in some embodiments, the mobile device 110 may be configured to share the signature-landmark database 180 with other devices. Such sharing may be facilitated through the network 160, a server, directly, or by any other means (e.g., Bluetooth, Wi-Fi, Near-Field Communication, etc.). As a result, other devices with relatively less processing power than the mobile device 110 may benefit from the signature-landmark associations generated by the mobile device 110 in the signature-landmark database 180. For example, other devices may use the shared data stored in the signature-landmark database 180 to also perform location estimation in an indoor environment. Furthermore, other devices may also be configured to generate signature-landmark associations and to store the respective associations into the signature-landmark database 180. As a result, the signature-landmark database may be enhanced with data input by a relatively wide range of devices with various capabilities with respect to sensors, processor power, storage space, and/or the like. Therefore, over time, as the signature-landmark database 180 receives more signature-landmark associations, virtual landmarks in the indoor environment may be identified with increased accuracy and precision.

Thus, in other embodiments, in addition to generating signature-landmark associations, the mobile device 110 may also be configured to analyze the signature measurements 230 stored in the signature-landmark database 180 to determine a location of the mobile device 110 associated with the indoor environment. For example, the mobile device 110 may update one or more signature-landmark associations stored in the signature-landmark database 180 based on received signature measurements 230.

According to some embodiments, the localization and database generation module 150 may output data, which may be referred to as the localization module output 220. The localization module output 220 may be provided in a format readable by the operating system 214. It should be understood that various operating system may be suitable including, but not limited to, any version of Windows, Android, iOS, Symbian, Linux, and/or the like. Furthermore, a Global Positioning System (GPS) location 281 and an alternative location source 216, such as WiFi trilateration, Bluetooth localization and/or the like, may be used in conjunction with the localization and database generation module output 220. For example, when a user is in an indoor environment, the alternative location source 216 and/or the GPS 218 may be used to determine a general, coarse location of the mobile device 110. As such, the localization and database generation module output 220 may then be used by the operating system 214 to determine a more precise or refined indoor location of the mobile device 110.

In one or more embodiments, a statistical module (not shown) may also be included in the mobile device 110. The statistical module may perform various algorithms to calculate a statistical significance associated with each of the signature measurements 230. For instance, the statistical module may employ an entropy metric or a clustering algorithm to classify a uniqueness quotient corresponding to the signature measurements 230. As such, the statistical module may assign each of the signature measurements 230 with a probability distribution to capture its confidence level. Thus, the mobile device 110 may be able to assign different weights to the signature measurements 230 according to their signature characteristics, such as estimated quality or accuracy of the signature characteristics, in representing a virtual landmark.

Turning now to FIG. 2B, a system for location estimation using a mobile device 110 is illustrated according to one or more embodiments. In the scenario depicted in FIG. 2B, the mobile device 110 may have relatively less processing capability than it possessed with respect to its depiction in FIG. 2A. As such, the mobile device 110 may be referred to as a thick client or thick mobile device. Thus, the mobile device 110 in FIG. 2B may rely on the server 170 to perform some of the processing load for location estimation and generation of the signature-landmark database 180.

In certain embodiments, the localization and database generation module 150 may be included within the server rather than in the mobile device 110. Similarly, the signature-landmark database 180 and map 250 may also be included within the server 170. Thus, while some operations related to location estimation may be performed in the mobile device 110, other operations may be performed by the server. For example, the signature-landmark module 224 of the mobile device 110 may be capable of aggregating signature measurements 230, and the relative motion module 222 may still be configured to receive inertial data from the inertial measurement module 202. However, the signature measurements 230 and the adjustment calculations from the relative motion module 222 may then be sent to the server 170 where the localization and database generation module 150 may process such information.

According to some embodiments, the signature-landmark database 180 may be shared with other devices through the network 160, including the mobile device 110. To this end, when the mobile device 110 of FIG. 2B requests location estimation, the mobile device 110 may query the server and/or the signature-landmark database 180 using the signature measurements 230, which may have been adjusted by the relative motion module 222. The signature-landmark database 180 may return a result, which may include a virtual landmark that corresponds to the signature measurements 130. Alternatively, instead of querying the server, the mobile device 110 may download all or a portion of the signature-landmark database 180 from the server 170 and perform location estimation locally.

In some embodiments, because the size of the signature-landmark database 180 may be relatively large, the mobile device 110 may download a portion of the signature-landmark database 180. As such, the mobile device 110 may include a coarse location prediction module 255 to predict an approximate movement of the mobile device 110. Using the approximate movement data provided by the coarse location prediction module 255, and data included in the signature measurements 230, the mobile device 110 may load a particular portion of the signature-landmark database 180 that corresponds to such approximations. Compared with downloading the entire signature-landmark database 180, this approach may save space in the memory 130 and/or storage 140. To this end, the database data 260 in FIG. 2B may represent a particular portion of the signature-landmark database 180 downloaded by the mobile device 110.

Additionally, in certain embodiments, the mobile device in FIG. 2B may also be capable of generating its own signature measurements 230 and generating signature-landmark associations to be stored in the signature-landmark database 180. For example, in some embodiments, the sensors used to capture the signature measurements 230 (e.g., inertial measurement module 202, camera 240, speaker 242, microphone 244, etc.) may be of relatively lower quality/accuracy/precision than those of the mobile device 110 illustrated in FIG. 2A. However, such signature measurements 230 may still retain value by enhancing the accuracy in identifying a particular virtual landmark. Thus, the localization and database generation module may store the signature measurements 230 in the signature-landmark database 180 in order to enhance signature measurements currently used to identify the particular virtual landmark.

Turning now to FIG. 2C, another system for location estimation using a mobile device 110 may be illustrated according to one or more embodiments of the present disclosure. In some embodiments, the mobile device 110 depicted in FIG. 2C may have relatively low processing capabilities, and indeed, lower than the devices depicted in FIG. 2A and FIG. 2B. As such, the mobile device 110 depicted in FIG. 2C may be referred to as a thin client and/or a thin mobile device.

According to one or more embodiments, the signature measurements 230 collected by the mobile device of FIG. 2C may be limited to wireless signal data 238 aggregated by the cellular radio and the WiFi radio 248. The mobile device 110 may therefore rely on the server 170 to provide a relatively large portion of the processing related to location estimation. Thus, the server 170 may include the localization and database generation module 150, the signature-landmark database 180, and the map 250. Alternatively, the mobile device 110 may rely directly on another mobile device (e.g., fat mobile device 110 of FIG. 2A) to perform location estimation and signature-landmark database 180 generation.

In some embodiments, the mobile device 110 may include a coarse location prediction module 255 to determine an approximate movement and/or position of the mobile device 110. Using the approximate movement data provided by the coarse location prediction module 255, and the data included in the signature measurements 230, the mobile device 110 may load a particular portion of the signature-landmark database 180 (i.e., the database data 260).

Thus, each of the mobile devices 110 in FIGS. 2A-2C may be able to share and/or store signature-landmark associations in the signature-landmark database 180. Thus, as more signature-landmark associations are shared and stored, the signature-landmark database 180 may gradually become more robust. Eventually, the signature-landmark database 180 may be such that a thin mobile device (e.g., mobile device 110 in FIG. 2C) may experience increased performance in location estimation quality (e.g., localization accuracy) with data provide by thick and/or fat mobile devices (e.g., mobile device 110 in FIGS. 2B and 2A, respectively). Because performance may be associated with the quality of the signature-landmark database 180, improvements to the signature-landmark database 180 may improve performance.

In other words, crowd sourcing signature measurements 230 and signature-landmark associations (e.g., via the signature-landmark association module 224) may enable the signature-landmark database 180 to be built relatively quickly. Additionally, using multiple data-points from diverse sets of devices, having a diverse set of sensors, may allow for adjustments and/or corrections of random errors that may be present in the calculations of individual mobile devices 110. In some implementations, the server 170 may also perform offline calculations and processing to adjust/improve accuracy and precision of data stored within the signature-landmark database 180.

Moreover, in some embodiments, the localization and database generation module output 220 may be provided as just one of multiple location sources to the operating system 214. Specifically, the localization and database generation module output 220 may be associated with a relative high degree of accuracy with regard to localization of the mobile device 110 in an indoor environment. Therefore, with regard to location estimation in an indoor environment, the operating system 214 may rely on the localization and database generation module output 220. In some embodiments, the localization output 220 may also be used to enhance other location sources. For instance, the localization output 220 may be used by the GPS 218 location source to reduce time-to-first-fix (TTFF) for the GPS 218.

According to one or more embodiments, the operating system 214 may choose from any of its available location sources (e.g., localization and database generation module output 220, GPS 218, and/or alternative location source 216) that it determines is suitable for a particular environment. Furthermore, the operating system 214 may be configured to provide additional constraints for signature-landmark association module 224 and/or the coarse location prediction module 255.

It should be noted that the mobile devices 110 illustrated in FIGS. 2A-C are merely example embodiments. As such, any of the mobile devices 110 illustrated may have more or less of the components depicted. For example, the thin mobile device 110 in FIG. 2C may include more sensors, such as a camera 240, while the thick mobile device 110 of FIG. 2B may be missing the camera. Additionally, the localization and database generation module 150 may be located in any of the mobile devices 110 of FIGS. 2A-C, the server 170, or any combination of the above. Furthermore, any of the components illustrated as included within the mobile device 110 and/or the server 170 may be distributed in any combination between the mobile device 110 and the server 170. Thus, any of the processing described above with respect to determining a location of a mobile device 110 may be distributed among the mobile device 110 and the server 170 in any fashion.

FIG. 3 depicts a relative motion tracking module 322 according to one or more embodiments of the present disclosure. The relative motion tracking module 222 may include a distance estimation module 310, an orientation estimation module 320, a frame transformation module 330, and an inertial calculation module 340. In addition, the relative motion tracking module 322 may be in communication with the localization and database generation module 150 as well as various sensors, such as an accelerometer 304, a gyroscope 306, a magnetometer 310, and a camera 340.

According to certain embodiments, the distance estimation module 310 may receive information from the accelerometer 304 and the camera 340 to measure the distance the mobile device 110 has traveled. The orientation module 320 may be configured to receive information from the accelerometer 304, the gyroscope 306, the magnetometer 310, and/or the camera 340. To this end, the orientation module 320 may determine a change in orientation of the mobile device 110. Furthermore, the distance estimation module 310 and/or the orientation estimation module 320 may perform their respective calculations according to when measurements from the inertial measurement module 202 and/or the signature measurements 230 may be received.

In one or more embodiments, the frame transformation module 330 may receive data from the distance estimation module 310 and the orientation estimation module 320, which may perform their respective calculations based on a coordinate frame relative to the mobile device 110 (e.g., a coordinate frame in which the origin is positioned at the center of the mobile device). As such, the frame transformation module 330 may transform the mobile device 110 coordinate frame to a navigational coordinate frame. The navigational coordinate frame may take into account the mobile device's 110 position relative to user and/or indoor environment. Thus, the calculations performed by the distance estimation module 310 and the orientation estimation module 320 may be placed in the appropriate context.

As a result, the mobile device 110 may be configured to adjust signature measurements 230 based on one or more motion tracking measurements. The mobile device 110 may also be configured to adjust motion tracking measurements based on the signature measurements 230. Thus, the signature measurements 230 and the motion tracking measurements may benefit from each other's associated measurements.

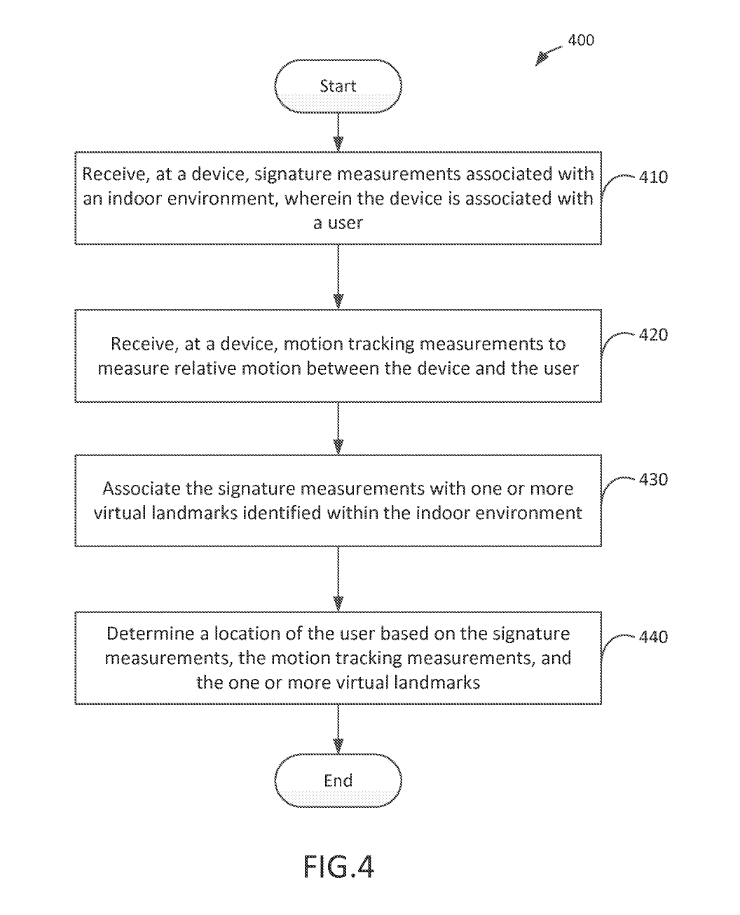

FIG. 4 represents a flow diagram of a method 400 for location estimation using a mobile device according to one or more embodiments of the present disclosure. The method 400 may begin in block 410, where a device, such as mobile device 110 receives signature measurements 130 associated with an indoor environment. For example, the mobile device may receive various types of data, including, but not limited to, inertial dynamics data 232, video/image data 234, audio data 236, or wireless signal data 238. To this end, such data may be assigned respective weights, according distinctiveness, and may be combined to generate signature measurements 230. Additionally, the mobile device 110 may be associated with a user.

Then, in block 420, the mobile device 110 may receive motion tracking measurements to measure relative motion between the mobile device 110 and the user. In other words, as previously discussed, the signature-measurements 130 may be adjusted for errors in calculations that may result from movement of the mobile device 110 relative to the user. For example, a relative motion tracking module 222 may calculate any corrections that may be made to the signature measurements 130. To this end, the relative motion tracking module 222 may calculate distance and orientation information related to movement of the mobile device 110 (e.g., using the distance estimation module 310 and the orientation estimation module 320).

In block 430, the mobile device 110 may associate the signature measurements 130 with one or more virtual landmarks associated with the indoor environment. For example, a signature-landmark association module 234 may receive the signature measurements 130 and identify one or more particular combinations of the signature measurements 130 as a virtual landmark.

Thus, in block 440, the localization and database generation module 150 may then generate the signature-landmark database 150 or portions thereof by generating one or more signature-landmark associations to be stored in the signature-landmark database 180. Alternatively, the mobile device 110 may not include enough processing capability to generate signature-landmark associations. Thus, the mobile device 110 may rely on previous entries in the signature-landmark database 180 generated by other mobile devices. As such, the mobile device 110 may query the signature-landmark database 180 to check if the signature measurements 130 match any of the virtual landmarks stored in the signature-landmark database 180.

In block 450, the mobile device 110 may determine a location of the user based on the signature measurements 130, the motion tracking measurements, and the one or more virtual landmarks. For example, the localization and database generation module 150 may receive information relative motion tracking module 222, the signature-landmark association module 224, the map 250, and/or the signature-landmark database 180. As described above, the localization and database generation module 150 may use such information to determine a location (e.g., an indoor location within the indoor environment) of the mobile device 110, and by extension, the user. In some embodiments, the steps performed in block 440 and 450 may be performed simultaneously or approximately simultaneously. In other embodiments, the steps performed in block 440 and block 450 may be performed at different points in time.

Certain embodiments of the present disclosure are described above with reference to block and flow diagrams of systems and methods and/or computer program products according to example embodiments of the present disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the present disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the present disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the present disclosure have been described in connection with what is presently considered to be the most practical and various embodiments, it is to be understood that the present disclosure is not to be limited to the disclosed embodiments, but is intended to cover various modifications and equivalent arrangements included within the scope of the appended claims. Although specific terms are employed herein, they are used in a generic and descriptive sense only and not for purposes of limitation.

This written description uses examples to disclose certain embodiments of the present disclosure, including the best mode, and also to enable any person skilled in the art to practice certain embodiments of the present disclosure, including making and using any devices or systems and performing any incorporated methods. The patentable scope of certain embodiments of the present disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method, comprising:
receiving, by a device comprising one or more processors, one or more signature measurements associated with an indoor environment, wherein the device is associated with a user;
receiving, at the device, one or more motion tracking measurements that are associated with relative motion of the device with respect to one or more aspects of the indoor environment and relative motion of the device with respect to the user;
associating, by the device, the one or more signature measurements with one or more virtual landmarks identified within the indoor environment; and
determining a location of the device based on the one or more signature measurements and the one or more motion tracking measurements.

2. The method of claim 1, wherein determining the location of the device is further based on one or more location sources or the one or more virtual landmarks.

3. The method of claim 1, wherein the one or more signature measurements comprise one or more of wireless signal data, video data, audio data, or inertial dynamics data.

4. The method of claim 3, wherein the wireless signal data comprises one or more of radio strength data, time of flight data, or time difference of arrival data.

5. The method of claim 1, further comprising
adjusting the one or more signature measurements based on the one or more motion tracking measurements.

6. The method of claim 1, further comprising generating a database to store one or more signature-landmark associations, between the one or more signature measurements and the one or more virtual landmarks, wherein the one or more virtual landmarks correspond to one or more coordinates and respective combinations of the one or more signature measurements.

7. The method of claim 6, further comprising sharing the one or more signature-landmark associations with another device.

8. The method of claim 6, further comprising:
receiving one or more additional signature measurements and one or more additional relative motion measurements; and
updating at least one of the one or more signature-landmark associations in the database based on the one or more additional signature measurements and the one or more additional motion tracking measurements.

9. The method of claim 1, further comprising downloading one or more signature-landmark associations, between the one or more signature measurements and the one or more virtual landmarks, from a database generated by another device.

10. The method of claim 1, further comprising associating the one or more signature measurements with respective weights based on respective signature characteristics of the signature measurements.

11. The method of claim 1, further comprising receiving a map of the indoor environment, wherein determining the location of the user is further based on the map.

12. The method of claim 1, wherein the one or more motion tracking measurements comprise information associated with inertial dynamics of the device.

13. A system, comprising:
a memory storing instructions;
a processor to execute the instructions to:
receive one or more signature measurements associated with an indoor environment;
receive one or more motion tracking measurements that are associated with relative motion of a device with respect to the indoor environment and relative motion of the device with respect to a user associated with the device;
associate the one or more signature measurements with one or more virtual landmarks identified within the indoor environment; and
determine a location of the user based on the one or more signature measurements, the one or more motion tracking measurements, and the one or more virtual landmarks.

14. The system of claim 13, wherein the instructions to determine the location of the user comprise instructions to determine an indoor location, within the indoor environment, of the device.

15. The system of claim 13, wherein at least a portion of the one or more motion tracking measurements are adjusted by one or more camera sensors.

16. The system of claim 13, wherein the processor is to execute further instructions to generate a database to store one or more signature-landmark associations, between the one or more signature measurements and the one or more virtual landmarks, wherein the one or more virtual landmarks correspond to one or more coordinates and respective combinations of the one or more signature measurements.

17. The system of claim 16, wherein the processor is to execute further instructions to share at least one of the one or more signature-landmark associations with other devices.

18. The system of claim 13, wherein the processor is to further execute instructions to:
receive additional signature measurements and additional motion tracking measurements; and
update at least one of the one or more signature-landmark associations in the database based at least in part on the additional signature measurements and the additional motion tracking measurements.

19. The system of claim 13, further comprising one or more sensors to:
generate the one or more signature measurements comprising at least one of video data, image data, audio data, or inertial dynamics data associated with the indoor environment.

20. A computer readable medium storing instructions, that when executed by a processor, cause the processor to:
receive, at a device, one or more signature measurements associated with an indoor environment, wherein the device is associated with a user;
receive, at the device, one or more motion tracking measurements that are associated with relative motion of the device with respect to the indoor environment and relative motion of the device with respect to the user;
associate the one or more signature measurements with one or more virtual landmarks identified within the indoor environment;
generate a database to store one or more signature-landmark associations between the one or more signature measurements and the one or more virtual landmarks; and
determine a location of the user based on the one or more motion tracking measurements and the one or more virtual landmarks, wherein the one or more virtual landmarks correspond to one or more coordinates and respective combinations of the one or more signature measurements.

21. The computer readable medium of claim 20, further comprising instructions to update the one or more virtual landmarks in the database with additional signature measurements corresponding to the respective one or more virtual landmarks.

22. The computer readable medium of claim 20, further comprising instructions to share, via the database, one or more associations between the one or more signature measurements and the one or more virtual landmarks, with another device.

23. The computer readable medium of claim 20, wherein the instructions to determine the location of the user comprises instructions to determine a Global Positioning System (GPS) location using the one or more signature measurements, the one or more motion tracking measurements, and the one or more virtual landmarks.

24. An apparatus, comprising:
a signature-landmark association module configured to receive one or more signature measurements associated with an indoor environment, the signature-landmark association module further configured to associate the one or more signature measurements with one or more virtual landmarks identified within the indoor environment;
a relative motion tracking module configured to receive one or more motion tracking measurements that are associated with relative motion of a device with respect to the indoor environment and relative motion of the device with respect to a user associated with the device; and
a localization and database generation module to determine a location of the user based on the one or more signature measurements, the one or more motion tracking measurements, and the one or more virtual landmarks.

25. The apparatus of claim 24, further comprising one or more sensors to generate the one or more signature measurements.

26. The apparatus of claim 25, wherein the one or more sensors comprise at least one of a camera, a microphone, a speaker, or a wireless radio.

27. The apparatus of claim 24, further comprising one or more sensors to generate the one or more motion tracking measurements.

28. The apparatus of claim 27, wherein the one or more sensors comprise at least one of an accelerometer, a gyroscope, a pressure sensor, or a magnetometer.
